(19) United States
(12) Patent Application Publication
(10) Pub. No.: US 2006/0037651 A1
(43) Pub. Date: Feb. 23, 2006

(54) Valve for mixing cold and hot water

(76) Inventor: Tsai Chen Yang, Taichung (TW)

Correspondence Address: Tsai Chen Yang, P.O. Box 63-99, Taichung, 406, TW

(21) Appl. No.: 10/923,205

(22) Filed: Aug. 23, 2004

(51) Int. Cl. F16K 11/074

(52) U.S. Cl. 137/625.41

(57) ABSTRACT

A valve includes a housing having two opposite juts and a bore and a projection, a plate having two curved oblong holes and a stem rotatably received in the bore of the housing, and a follower secured to the stem and having an extension for engaging with the projection of the housing. A base includes two inlets and two hubs aligned with the inlets, and an outlet, and an upper peripheral wall having two notches oppositely formed in an inner peripheral portion and each formed by an outer fence member. The juts of the housing are engageable into the notches of the base, and engageable into different notches of the base when the housing is rotated for 180 degrees relative to the base.

### BACKGROUND OF THE INVENTION

1. Field of the Invention

The present invention relates to a valve, and more particularly to a valve for mixing cold and hot water.

2. Description of the Prior Art

Typical valves for mixing cold and hot water comprise a first inlet coupled to a cold water reservoir and a second inlet coupled to a hot water reservoir for receiving the cold water and the hot water from the cold water reservoir and the hot water reservoir respectively. The typical valves further include a control mechanism for controlling the flowing and/or the mixing of the cold water and the hot water.

When the first inlet is wrongly coupled to the hot water reservoir and when the second inlet is wrongly coupled to the cold water reservoir, the cold water and the hot water may be wrongly supplied into the valve such that the valve, particularly the knob of the valve may be operated in different actuation or rotation directions from that of the usual directions of the typical valves. The users may not operate the valve in the way that they typically operate the typical valves for mixing hot water and cold water.

For allowing the users to operate the valve in the way that they typically operate the typical valves for mixing hot water and cold water, and for preventing the users from being hurt by hot water inadvertently, the applicant has developed an improved valve for mixing cold and hot water, which has been allowed and issued as U.S. Pat. No. 6,123,105 to Yang.

In Yang, a base includes two juts and two hooks extended outwardly therefrom for engaging into corresponding notches and channels of a housing. However, the juts and the hooks are extended outwardly from the base, for engaging into the corresponding notches and channels of the housing, such that additional gaskets or sealing rings are required to be provided and engaged between the housing and the base. In addition the outwardly extended juts and hooks of the housing may spoil the outer appearance of the housing.

The present invention has arisen to mitigate and/or obviate the afore-described disadvantages of the conventional water valves for mixing cold and hot water.

### SUMMARY OF THE INVENTION

The primary objective of the present invention is to provide a valve which includes a symmetric mechanism which may be assembled according to the cold water inlet and the hot water inlet of the valve body.

The other objective of the present invention is to provide a valve including a housing rotatable and adjustable relative to the base to the other position relative to the base, to allow hot water and cold water to be suitably supplied into the valve.

In accordance with one aspect of the invention, there is provided a valve comprising a housing including two juts oppositely extended therefrom, the housing including a bore formed therein and including a projection extended therefrom, a plate including a pair of curved oblong holes formed therein and including a stem extended therefrom and rotatably received in the bore of the housing, a follower secured to the stem and including an extension extended therefrom for engaging with the projection of the housing and for limiting a rotational movement between the stem and the housing, a base including two inlets formed therein and including two hubs provided therein and aligned with the inlets respectively, and including an outlet formed therein, the base including an upper peripheral wall having two notches oppositely formed in an inner peripheral portion thereof, and each defined by an outer fence member, two gaskets received in the hubs and engaged with the plate, and means for biasing the gaskets to engage with the plate. The juts of the housing are engageable into the notches of the base, for detachably securing the base to the housing, and engageable into different notches of the base when the housing is rotated for 180 degrees relative to the base.

The stem includes a first engaging member, the follower includes a second engaging member for engaging with the first engaging member of the stem and for securing the stem to the follower and for allowing the stem and the follower to be rotated in concert with ea.ch other.

A ring may further be provided and secured to the housing and includes a stop extended therefrom for engaging with the extension of the follower and for limiting a rotational movement between the stem and the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a valve in accordance with the present invention;

FIG. 2 is a partial exploded view of the valve;

FIG. 3 is an enlarged partial perspective view of the valve;

FIGS. 4, 5, 6, 7, 8, 9, 10, 11 are plane schematic views illustrating the operation of the valve; and

FIG. 12 is a partial exploded view of the valve similar to FIG. 2, in which the upper portion or the upper housing of the valve is rotated for 180 degrees re1atlive to the base.

### DETAILED DESCRIPTION OF THE PREFERRED EMBODIMENT

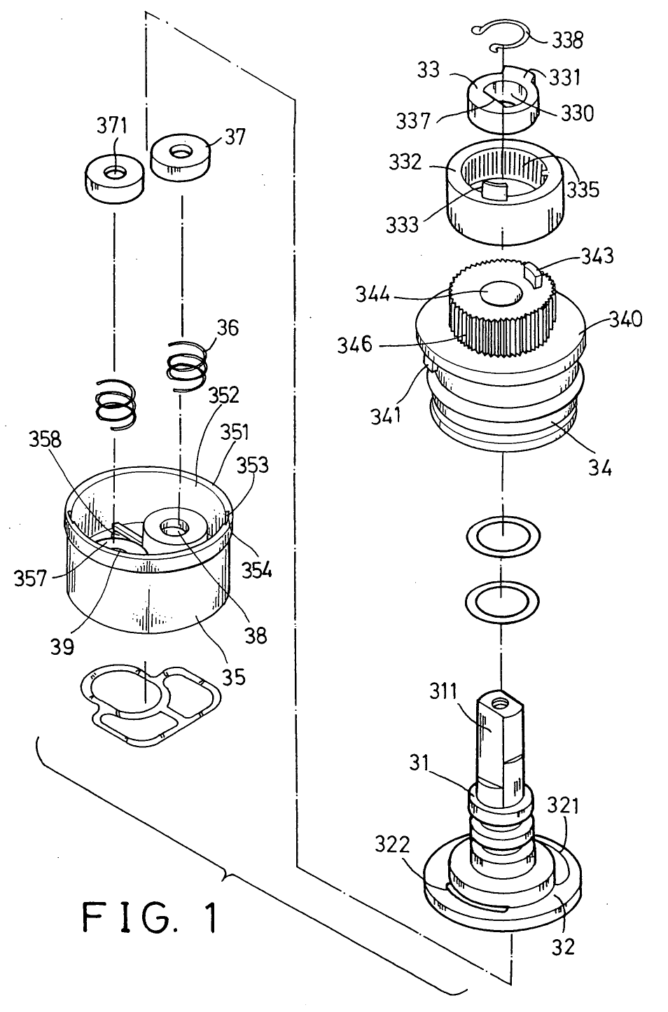

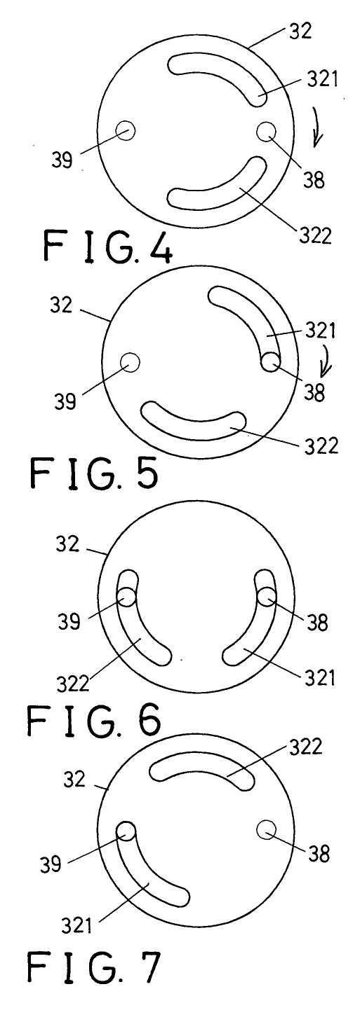

Referring to the drawings, and initially to FIGS. 1-3, a valve in accordance with the present invention comprises a housing 34 including a peripheral flange 340 extended radially outward from the middle portion thereof and including one or more, such as two jus 341 oppositely extended from the bottom portion of the peripheral flange 340 of the housing 34.

It is preferable that the two juts 341 are oppositely formed in the housing 34 and arranged 180 degrees apart from each other. The housing 34 includes a bore 344 formed therein and includes a projection 343 extended upward therefrom. The housing 34 preferably includes a gear 346 formed on the upper portion thereof.

A plate 32 includes a stem 31 extended upwardly therefrom and rotatably engaged into the bore 344 of the housing 34 and includes a pair of curved oblong holes 321, 322 formed therein. The stem 31 includes an engaging member, such as a key or an engaging flat surface 3 11 formed therein.

A follower 33 includes an orifice 330 formed therein for receiving the stem 31 and includes an engaging member, such as a groove for receiving the corresponding key of the stem 31 or such as another engaging flat surface 337 formed therein for engaging with the engaging flat surface 311 of the stem 31 and for allowing the follower 33 to be secured to and to be rotated in concert with the stem 31.

The follower 33 includes an extension 331 extended therefrom for engaging with the projection 343 of the housing 34 and for limiting the rotational movement between the stem 31 and the housing 34. A retaining ring 338 may further be secured to the stem 31 and engaged with the follower 33 for further securing the follower 33 to the stem 31.

A ring 332 includes a stop 333 extended upward therefrom and includes an internal gear 335 formed therein for engaging with the gear 346 of the housing 34 and for securing the ring 332 to the housing 34. The stop 333 of the ring 332 is slightly extended radially inward of the ring 332 and may further be provided for engaging with the extension 331 of the follower 33 and for limiting the rotational movement between the stem 31 and the housing 34. Normally, a knob (not shown) is secured to the top of the stem 31 for rotating the stem 31 relative to the housing 34.

A base 35 is to be secured to a typical valve housing or the like and includes two inlets 38, 39 formed therein for coupling to a cold water reservoir and a hoi water reservoir, for receiving cold water and hot water from cold water reservoir and hot water reservoir respectively.

The base 35 includes two hubs 357 provided therein and aligned with the inlets 38, 39 respectively, and the hubs 357 of the base 35 are each provided for receiving a spring 36 and a gasket 37 respectively. The gaskets 37 are biased to engage with the plate 32 by the springs 36 respectively for making a water tight seal between the gaskets 37 and the plate 32, and each gasket 37 includes a bore 371 formed therein for communicating with the water inlets 38, 39 respectively. The base 35 includes an outlet 358 formed therein.

The base 35 further includes an upper peripheral wall 351 having one or more, such as two notches 353 oppositely formed in the inner peripheral portion 352 thereof, and each defined by an outer fence member 354, for receiving the corresponding juts 341 of the housing 34, and for detachably securing and anchoring the base 35 to the housing 34, and for preventing the housing 34 from being rotated relative to the base 35.

It is to be noted that the juts 341 of the housing 34 may be engaged into the notches 353 of the base 35, and may be shielded by the outer fence members 354 of the base 35, for preventing the juts 341 of the housing 34 from being exposed.

When either or both of the curved oblong holes 321, 322 of the plate 32 are communicating with either or both of the inlets 38, 39 (FIGS. 5-7 and 9-11), the curved oblong holes 321, 322 include a length or a size greater than that of the hubs 357 and/or of the gaskets 37 for allowing the water from the inlets 38, 39 to flow into the base 35 and flow out through the outlet 358 of the base 35 via the curved oblong holes 321, 322 of the plate 32.

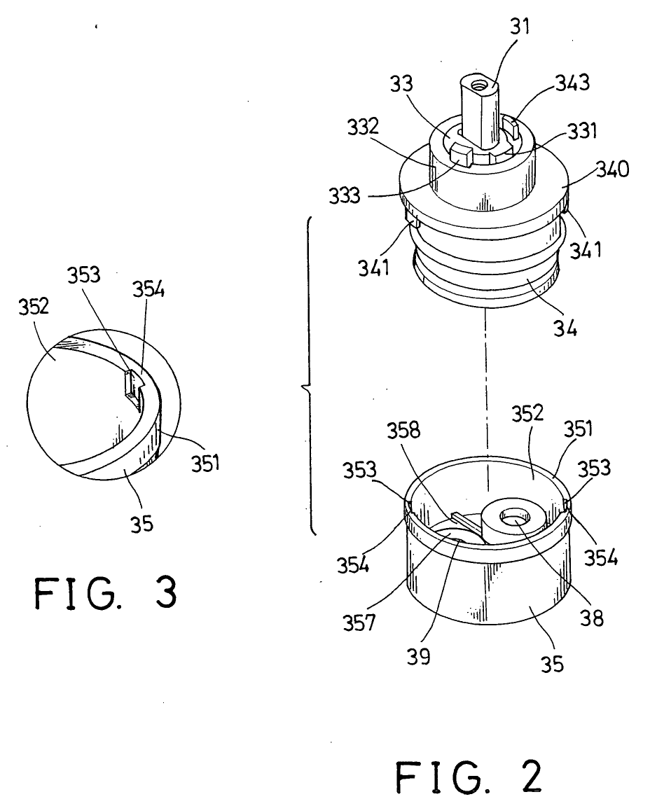

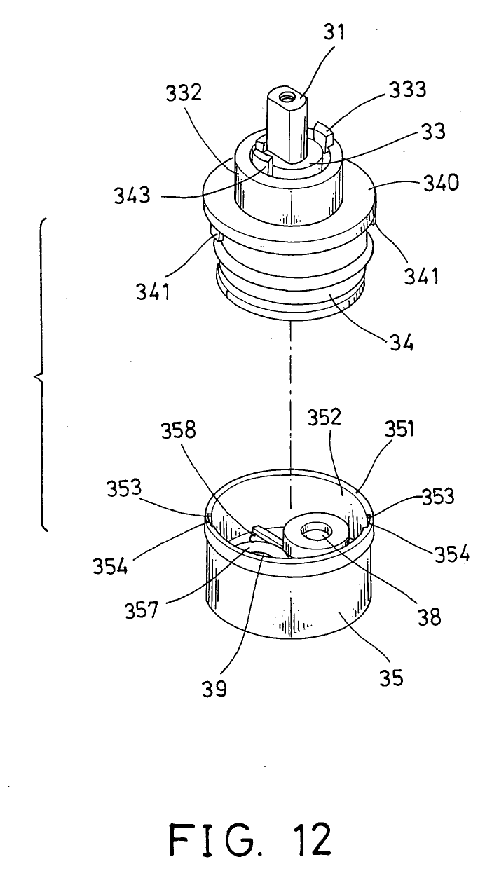

It is to be noted that the juts 341 of the housing 34 and the notches 353 of the base 35 are arranged symmetric to each other or are arranged 180 degrees apart from each other such that the housing 34 may also be rotated for 180 degrees relative to the base 35 (FIGS. 2, 12) and secured to the base 35 with the symmetric pair of the juts 341 of the housing 34 and the notches 353 of the base 35.

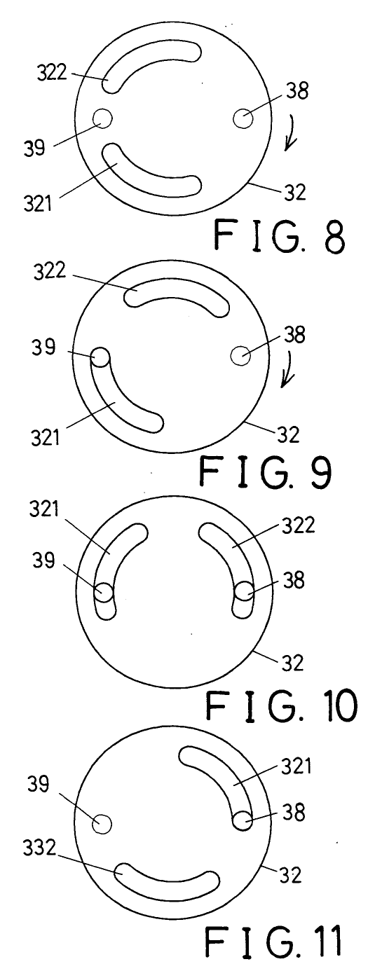

In operation, as shown in FIGS. 4-7, both the cold water and the hot water may not flow into and out through the valve when the curved oblong holes 321, 322 of the plate 32 are disengaged from the water inlets 38, 39. When the inlet 38 is coupled lo the cold water reservoir and the inlet 39 is coupled to the hoi water reservoir respectively, and when the plate 32 is rotated clockwise relative to the base 35, the curved oblong hole 321 is first coupled to the water inlet 38 (FIG. 5) for receiving the cold water from the cold water reservoir, such that the cold water may first flow out through the outlet 358 of the base 35.

As shown in FIG. 6, when the plate 32 is further rotated clockwise relative lo the base 35, the curved oblong holes 321, 322 of the plate 32 may be coupled to the water inlets 38, 39 respectively for receiving the cold water and the hot water to be mixed in the base 35 and then to flow out through the outlet 358 of the base 35.

As shown in FIG. 7, when the plate 32 is further rotated clockwise relative to the base 35, the curved oblong hole 322 may be disengaged from the inlets 38, 39 and the other oblong hole 321 of the plate 32 may be coupled to the hot water inlet 39 for receiving the hot water and for allowing the hot water to flow out through the outlet 358 of the base 35.

When the inlet 39 is wrongly coupled to the cold water reservoir and when the inlet 38 is wrongly coupled to the hot water reservoir respectively, the housing 34 and the plate 32 may be rotated for 180 degrees relative to the base 35, from such as FIG. 2 to FIG. 12, for allowing the curved oblong hole 321 to communicate with the cold water inlet 39 first (FIG. 9).

When the plate 32 is also rotated clockwise relative to the base 35, the curved oblong hole 321 is first coupled to the water inlet 39 for receiving the cold water from the cold water reservoir, such that the cold water may also first flow out through the outlet 358 of the base 35.

As shown in FIG. 10, when the plate 32 is further rotated clockwise relative to the base 35, the curved oblong holes 321, 322 of the plate 32 may-be coupled to the water inlets 38, 39 respectively for receiving the cold water and the hot water to be mixed in the base 35 and then to flow out through the outlet 358 of the base 35.

As shown in FIG. 11, when the plate 32 is further rotated clockwise relative to the base 35, the curved oblong hole 322 may be disengaged from the inlets 38, 39 and the oblong hole 321 of the plate 32 may be coupled lo the hot water inlet 38 for receiving the hot water and for allowing the hot water to flow out through the outlet 358 of the base 35.

Accordingly, the valve in accordance with the present invention includes a symmetric mechanism which may be assembled according to the cold water inlet and the hot water inlet of the valve body, and includes a housing rotatable and adjustable relative to the base to the other position relative to the base, to allow hot water and cold water to be suitably supplied into the valve.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A valve comprising:
a housing including two juts oppositely extended therefrom, said housing including a bore formed therein and including a projection extended therefrom,
a plate including a pair of curved oblong holes formed therein and including a stem extended therefrom and rotatably received in said bore of said housing,
a follower secured to said stem and including an extension extended therefrom for engaging with said projection of said housing and for limiting a rotational movement between said stem and said housing,
a base including two inlets formed therein and including two hubs provided therein and aligned with said inlets respectively, and including an outlet formed therein, said base including an upper peripheral wall having two notches oppositely formed in an inner peripheral portion thereof, and each defined by an outer fence member,
two gaskets received in said hubs and engaged with said plate, and
means for biasing said gaskets to engage with said plate, and
said juts of said housing being engageable into said notches of said base, for detachably securing said base to said housing, and engageable into different notches of said base when said housing is rotated for 180 degrees relative to said base.

2. The valve according to claim 1, wherein said stem includes a first engaging member, said follower includes a second engaging member for engaging with said first engaging member of said stem and for securing said stem to said follower and for allowing said stem and said follower to be rotated in concert with ea.ch other.

3. The valve according to claim 1 further comprising a ring secured to said housing and including a stop extended therefrom for engaging with said extension of said follower and for limiting a rotational movement between said stem and said housing.
